(19) United States
(12) Patent Application Publication
(10) Pub. No.: US 2024/0318387 A1
(43) Pub. Date: Sep. 26, 2024

(54) TRANSPORT SURFACE REINFORCEMENT SYSTEM

(71) Applicant: S&P CLEVER REINFORCEMENT COMPANY AG, CH-6423 Seewen (CH)

(72) Inventors: Jacob Moldrup Hansen, CH-6423 SEEWEN (CH); Klavs Olsen, CH-6423 SEEWEN (CH)

(73) Assignee: S&P CLEVER REINFORCEMENT COMPANY AG, CH-6423 Seewen (CH)

(21) Appl. No.: 18/678,559

(22) Filed: May 30, 2024

Related U.S. Application Data
(63) Continuation of application No. PCT/EP2022/083702, filed on Nov. 29, 2022.

(30) Foreign Application Priority Data
Nov. 30, 2021 (GB) 2117294.5

(51) Int. Cl. E01C 11/16; E01C 11/26

(52) U.S. Cl. CPC E01C 11/165; E01C 11/265

(57) ABSTRACT

A transport surface reinforcement system comprising a foundation layer having a first surface and a second surface, a top surface layer having a first surface and a second surface, a bituminous layer having a first surface and a second surface, where the second surface of the bituminous layer faces the first surface of the foundation layer, a reinforcement network having a first surface and a second surface where the reinforcement network is arranged on the first surface of the foundation layer, or between the foundation layer and the top surface layer, where the reinforcement network comprises a plurality of primary fibre structures extending along a primary axis, where the plurality of primary fibre structures are arranged at a distance from each other in a direction of a secondary axis, a plurality of secondary fibre structures extending along the secondary axis, where the plurality of primary fibre structures are arranged at a distance from each other in a direction of the primary axis, where at least one primary fibre structure intersects a secondary fibre structure, at least one electrical input, and a power source having an electrical output which is electrically connected to the reinforcement network configured to transfer electrical energy into the electrical input of the reinforcement network.

### CLAIM OF PRIORITY

This application is a continuation of, and claims priority to, PCT Patent Application No. PCT/EP2022/083702, entitled “A TRANSPORT SURFACE REINFORCEMENT SYSTEM”, filed Nov. 29, 2022, which claims priority to GB Patent Application No. 2117294.5, entitled “A TRANSPORT SURFACE REINFORCEMENT SYSTEM, filed Nov. 30, 2021, which applications are incorporated by reference herein in their entirety.

### TECHNICAL FIELD

The subject matter relates to a transport surface reinforcement system comprising a foundation layer having a first surface and a second surface, a top surface layer having a first surface and a second surface, a bituminous layer having a first surface and a second surface, where the second surface of the bituminous layer faces the first surface of the foundation layer, and a reinforcement network having a first surface and a second surface, where the reinforcement network is arranged on the first surface of the foundation layer, or between the foundation layer and the top surface layer.

### BACKGROUND

Currently there are a large number of transport surfaces in the world that are engineered (civil engineering), such as roads, pavements, hard-standings, runways, etc. (referred to collectively, in certain jurisdictions, as “pavements”, or as “engineered surfaces”, and referred to hereinafter as “transport surfaces”, a term which encompasses all of the foregoing, at least) used to improve transportation logistics, e.g. in allowing wheeled vehicles to move safely from one position to another on a ground surface. A large number of these transport surfaces are located in environments where there may be large variations in temperature based on seasons and weather systems.

Some of these transport surfaces in the modern environment may be reinforced, in order to attempt to increase their life span and to improve safety. One of the biggest challenges when dealing with transport surfaces in cold areas is snow or ice covering the top surface of the transport surface. Snow and ice on the top surface may make the transport surface unsafe and dangerous for vehicles that travel on the transport surface.

There are currently a number of ways in which slippery transport surfaces are dealt with, one of which is to spread salt. However, there is a negative environmental effect of doing this, as the salt (together with any associated grit or sand) may pollute the surrounding environment, and the salt may lead to corrosion of the transport surface and/or technical installation as well as the vehicles using the transport surface. Another way is to remove the snow e.g. by using specialized machines, such as snowplows, to remove any snow or ice. The use of any of these measures is also time and energy consuming. In some countries, transport surfaces may be heated up using fluid lines that are installed under the surface of the transport surface, where warm fluids flow through the lines to heat up the transport surface and melt the snow or ice. This solution is very expensive, and may make the transport surface very difficult to repair, as damage to the transport surface may cause the lines to break, and the lines themselves are also difficult to repair. Furthermore, this may reduce the strength of the transport surface, which means that the solution may not be used on e.g. an airport runway and/or a road.

Previously, asphalt has been mixed with carbon fibres to create an asphalt that is electrically conductive, and allows an application of electrical current into the asphalt enabling it to heat up. However, this mixture does not solve the issue of asphalt having high tensile strength, as the carbon fibre does not reinforce the asphalt sufficiently for it to be used for heavy traffic, as the viscosity of asphalt is unable to withstand heavy usage, e.g. at bus stops, airplane parking at airports and so on.

Thus, there is a need to provide a transport surface having a high strength and where the transport surface may be provided with heat energy in order to melt ice or snow in areas where there is a risk of ice being formed on the transport surface.

### DESCRIPTION

In accordance with the described technology, there is provided a transport surface reinforcement system comprising a foundation layer having a first surface and a second surface, a top surface layer having a first surface and a second surface, a bituminous layer having a first surface and a second surface, where the second surface of the bituminous layer faces the first surface of the foundation layer, and a reinforcement network having a first surface and a second surface, where the reinforcement network is arranged on the first surface of the foundation layer (or between the foundation layer and the top surface layer) and where the reinforcement network comprises: a plurality of primary fibre structures extending along a primary axis, where the plurality of primary fibre structures are arranged at a distance from each other in a direction of a secondary axis, a plurality of secondary fibre structures extending along the secondary axis, where the plurality of primary fibre structures are arranged at a distance from each other in a direction of the primary axis, where at least one primary fibre structure intersects a secondary fibre structure, at least one electrical input, and a power source having an electrical output which is electrically connected to the reinforcement network configured to transfer electrical energy into the electrical input of the reinforcement network.

Within the context of the present disclosure the term network may mean a mesh, grid, net, web or any suitable term to disclose a network of fibres. Thus, the network may define surfaces.

In the present disclosure, the system is disclosed as being a layered construction, where each layer may have a first surface and a second surface. The first surface may face an opposite direction to the second surface, and where e.g. a first surface of one layer may face the second surface of the abutting or adjacent layer. Furthermore, parts of the layers, e.g. such as each strand, or bundles of strands of the fibre structures may also be defined as having a first surface and/or a second surface, the first surface facing the opposite direction to the second surface (e.g. one up, one down, by way of example only). The layers may abut or be arranged adjacent each other, but it may also be understood that parts of the layers may interact or fuse with, or within, another layer, so that the boundaries between the two layers is not clear cut, definite or absolute. Furthermore, one part of a single layer may have ingredients or components that are identical with another layer, so that parts of a layer may integrate with parts of another layer. One example of this may e.g. be if the fibre structures are coated with a bituminous substance, and a bituminous layer is applied on top of the coated fibres, the bituminous coating and the bituminous layer may fuse together and/or adhere to each other and create an adhesion between the two layers, as the coating and the layer may be homogenous and can easily bond with each other. Indeed, the fibres may be subsumed within the bituminous layer.

The transport surface reinforcement system may be seen as a layered construction, where the foundation layer may be seen as the layer that is adapted to prepare the ground surface for the placement of a transport surface. The top surface layer may be seen as the layer which will become the top surface of the transport surface, and may be an asphalt or concrete type of layer. In between these two layers, a reinforcement layer and a bituminous layer may be positioned, where the bituminous layer may be adapted to bind the top surface to the foundation layer, and where the bituminous layer may be configured to hold the reinforcement layer in position prior to the application of the top surface layer.

The reinforcement layer structure may be in the form of a network, where the primary fibre structure and the secondary fibre structure may be separated by a void. Thus, when the reinforcement layer structure is positioned on top of the foundation layer, and the bituminous layer is applied on top of the reinforcement network and the foundation, the bituminous layer will come into contact with the foundation layer via the voids (openings) in the network, for example. Thus, when the top surface layer has been applied, the first surface of the foundation is adhered, bonded or attached to the second surface of the top surface layer via the bituminous layer and/or the reinforcement structure.

The primary fibre structures and the secondary fibre structures of the reinforcement network may be in the form of fibres that have electrical conductivity, and are capable of transmitting an electrical current from a power source from a first part of the fibre to a second part of the fibre that is a distance away from the first part of the fibre. Thus, the primary fibre structure and/or the secondary fibre structure may be used to transmit electrical energy from one part of the reinforcement network to another part of the reinforcement network. Thus, the primary and/or the secondary fibre strands of the reinforcement network may be in electrical connection, allowing electrical current to be transmitted from a primary fibre strand to a primary fibre strand and/or a secondary fibre strand, or vice versa. This may e.g. be done by having a first part of the reinforcement network as a first pole and a second part of the reinforcement network as an opposing second pole (e.g. ground) allowing the electrical current to flow from the first pole to the second pole.

Thus, the reinforcement network may define a closed electrical circuit where the current may be transformed into thermal energy which may be transferred into the top surface layer of the transport surface system in one or more positions of the reinforcement network. Thus, by sending electrical energy into the reinforcement system, the reinforcement system may distribute the electrical energy into one or more positions of the reinforcement network, where the electrical energy may be transformed into thermal energy, and where the thermal energy may warm up the first surface of the top surface layer to a temperature that is above the freezing temperature of water (about 0 degrees Celsius at sea level), so that any snow, water or liquids that are present on the first surface will not create any ice on the first surface of the transport surface.

The top surface layer may be a layer such as an asphalt layer or a tarmac layer, where the layer may be a viscous layer. The reinforcement network may be a network that as a whole has low elongation properties, e.g. below 5% elongation properties, and/or have a high tensile strength, so that when a force is applied to the top surface layer, the reinforcement network will prevent the viscous flow of the top surface network in a direction away from the force applied and will improve the ability of the top surface layer to maintain its shape. This may also be applied when the top surface is composed of a material of low tensile strength, such as concrete, to increase the strength of the concrete. Thus, the reinforcement network may increase the tensile strength of the top surface layer.

The power source may be connected to the reinforcement network where the power source may e.g. be a power storage unit, a power supply, or a power converter which may be connected to an electrical supply network or similar electrical power sources that may deliver electrical energy in the form of an electrical current in an AC or DC voltage. The power source may e.g. have a power input and a power output, where the power output may be in electrical connection with the reinforcement network and/or the transport surface reinforcement system, while the power input may be connected to a second power source, such as electrical mains and/or a power grid.

The power source may be a variable power source, where electricity may be transmitted into the reinforcement network in accordance with the actual needs of the system. Thus, the power source may e.g. be connected to a temperature sensor, where a drop in temperature may initiate the transfer of electrical power into the reinforcement network.

The provision of a temperature increasing structure in the transport surface reinforcement system may reduce the cost of dealing with snow and ice management in e.g. an airport environment, where it may be difficult to shovel the snow away from certain areas of the airport, especially the areas close to the gates. Thus, it may be advantageous to melt the snow, in order to remove the need to move the snow away from the predefined areas of the airport.

The reinforcement network may be connected to the power source via a single power input into one fibre and/or one fibre bundle where the electrical energy may be distributed to the reinforcement network via conduction or induction into the reinforcement network. Additionally, the reinforcement network may be connected to a power input which may extend in order to introduce electrical energy into a plurality of positions of the reinforcement network. The reinforcement network may be connected to one or more opposing poles, allowing the electrical energy to transfer via the reinforcement network from a first pole (input) to a second pole (output), where the second pole may be in the form of one or more electrical connections.

In one exemplary embodiment each of the primary fibre structures and/or each of the secondary fibre structures may comprise a bundle of fibre strands. The fibre structures may be in the form of a plurality of fibre strands that abut each other to create a group of fibres that may be twisted, braided, gathered, or adhered together to create a fibre structure which in its cross section has a plurality of fibre strands that extend in the same direction, where at least one of the fibre strands is capable of conducting electricity from one longitudinal position of the fibre strand to another longitudinal position of the fibre strand.

In one exemplary embodiment each of the primary fibre structures and/or each of the secondary fibre structures may be made of at least 50% of carbon fibre strands. The carbon fibre strands may be graphite fibre strands, which have a high stiffness, high tensile strength, low weight, high chemical resistance, high temperature tolerance and low thermal expansion. The fibres may have a diameter that is between 5-20 micrometres in diameter. The primary fibre structures may have a mixture of fibre strands, where a first part of the fibre strands may be of a first material, and a second part of the fibre strands may be of a second material, and a third part of the fibre strands may be made of a third material and so on. The choice of the material may be made based on what the fibre structures are used for, i.e. where a fibre structure is intended to have a high tensile strength, the choice of material may be selected to reflect this. Furthermore, in order to improve electrical conductivity of the fibre structure, a specific conductive material may be introduced into the fibre strands, where the electrical conductivity of the specific conductive material may be different than that of the other strands in the fibre structure. An example is where one or more metal strands may be included in the fibre structure to improve the electrical conductivity of the fibre structure, and/or reduce the electrical resistance of the fibre structure.

In one exemplary embodiment the reinforcement network may transform the electrical energy into heat. The heat may be thermal energy, where the thermal energy may be infrared thermal energy. The thermal energy may be transmitted from the fibre structure and into the top surface layer, where the thermal energy may warm up the top surface layer. The heating may be in the form of Joule heating, or resistive heating, where the electrical current passing through the fibre structure produces heat that may be transferred into surrounding layers in the transport surface reinforcement system. The amount of thermal energy may depend on the magnitude of the electrical current, the specific composition of the fibre structure and/or the type of electricity that is introduced into the fibre structure, i.e. AC vs. DC.

The reinforcement network used may be S&P Carbophalt® G 200/200, which is a bitumen impregnated carbon fibre network, having mask sizes of 15×15 mm. The E-modulus of the carbon fibre may be between 240.000 N/mm² and 265.000 N/mm², having an extension at break of less than 1.9%, a tensile strength of 200 kN/m at <1.5% elongation, and having a fibre diameter of 46-47 mm²/m, or having around 50-52 fibres in a sectional diameter.

In one exemplary embodiment at least a first and/or a second surface of one of the primary fibre structures may intersect at least a first and/or a second surface of one of the secondary fibre structures. The primary fibre structure may be adapted to be laid out in a direction along a first axis, while the secondary fibres structure may be adapted to be laid out in a direction along a second axis, where the first axis and the second axis may be substantially perpendicular along a plane that is parallel to both axes (e.g. when the structures are positioned on a flat surface). The primary fibre structure and the secondary fibre structure may have a first surface and a second surface (e.g. top and bottom surfaces), where the primary fibre structure may intersect the secondary fibre structure, so that the first surface of the primary fibre structure is in contact with the second surface of the secondary fibre structure, and vice versa. This may mean that in the area where the primary fibre structure intersects the secondary fibre structure (where the primary fibre structure is opposite the secondary fibre structure), the fibre structure and/or the individual strands of the fibre structure may be perpendicular to each other. Thus, the intersection may be provided without any knots or bends in the fibre structure, which may mean that the height/width of the intersection is at maximum approximately the diameter/height of the primary fibre structure and the diameter/height of the secondary fibre structure.

In one exemplary embodiment, an electrical charge that is introduced into the primary fibre structures may be transferred at one or more intersections to the secondary fibre structures, where the transferral may be via conductive and/or inductive transfer of electrical energy. At least one of the fibres of the primary fibre structure may be in contact with at least one of the fibres in the secondary fibre structures, where the contact may allow electrically charged particles to move from one fibre structure to a second fibre structure. Alternatively, or additionally, an electrical charge may be transferred from one fibre structure to another fibre structure, or from an induction power source to one or more fibre structures via electromagnetic induction.

In one exemplary embodiment each of the primary fibre structures and/or the secondary fibre structures may have a first fibre bundle and a second fibre bundle extending parallel to each other, where an intersecting secondary fibre structure and/or primary fibre structure may pass between the first fibre bundle and the second fibre bundle. The primary fibre structure and/or the secondary fibre structure may be made of a plurality of individual fibre strands, where the individual fibre strands may be physically bundled together as one whole (creating one bundle) or in smaller bundles, i.e. two bundles of a plurality of fibre strands, in certain areas of the longitudinal length of the fibre structures. Thus, in an area where one primary fibre structure intersects a secondary fibre structure, or vice versa, the primary fibre structure may e.g. pass between two bundles of fibres in the secondary fibre structure. Thus, the secondary fibre structure may be positioned on a first side of the primary fibre structure and on a second side of the primary fibre structure. By doing this, it is possible to reduce the movement of one fibre structure relative to the other fibre structure, as the intersecting fibre structure will have friction on both sides of the fibre structure, and thereby increase the contact area between the two fibre structures. Furthermore, this limits the height of the fibre structure in the area of intersection, relative to known intersections, where the primary fibre structure may e.g. be attached to the secondary fibre structure.

In one exemplary embodiment the primary fibre structures may be woven with the secondary fibre structures. The weave between the primary fibre structures and the secondary fibre structures may be in the area where the primary fibre structure intersects with the secondary fibre structure, in order to fix the position of the primary fibre structure relative to the secondary fibre structure. This woven structure may mean that the primary fibre structures may alternate between being above and beyond the secondary fibre structures in the areas/regions where the two fibre structures intersect. The woven structure may be an interlacing structure, where the fibres of the primary structure are interlaced with the fibres of the secondary fibre structure, and may be at a right angle to each other. The woven structure in the intersection may be a low density woven structure, where the number of alterations pr. cm² in the woven areas may be low, or 3 alterations pr. cm² or lower.

In one exemplary embodiment intersecting primary fibre structures and the secondary fibre structures may be moveable along the first axis and/or the second axis prior to the application of the bituminous layer. This may mean that the fibre structures are not fixed relative to each other in the intersecting areas, i.e. that the primary fibre structures are not attached to the secondary fibre structures, and that the strands of each fibre structure may be seen as extending along a substantially straight curve past each other. The substantially straight curve means that the strands may bend slightly due to height differences, but that they do not curve beyond approximately 90 degrees in the intersecting areas. This means that the primary fibre structures and the secondary fibre structures are not tied together using knots, as is common.

In one exemplary embodiment at least part of the reinforcement network may penetrate the second surface of the bituminous layer. The bituminous layer may be applied on top of the reinforcement layer in the form of a liquid and/or viscous layer, which means that the material of the bituminous layer may penetrate the primary fibre structure and/or the secondary fibre structure, and/or the areas between the primary fibre structure and the secondary fibre structure. This allows the reinforcement layer to be integrated with the bituminous layer in some areas. The bituminous layer may also in some examples be introduced so that a part of the bituminous layer may be on a second side of the reinforcement layer, so that the bituminous layer may extend from the foundation layer and towards the top surface layer, and where the reinforcement layer may be embedded inside the bituminous layer.

In one exemplary embodiment the electrical energy may be DC current. The DC current may be transmitted from the electrical output of the power source, where the electrical output may be electrically connected via a wire to the reinforcement network, so that a DC current is capable of flowing along the fibre structure of the reinforcement network. The DC current may transform to thermal energy in predefined areas of the reinforcement network, or where a part of the DC current may be constantly transformed into thermal energy along the entire strand and/or strands of the fibre structure when the DC current flows from one pole to an opposing pole.

In one exemplary embodiment the reinforcement network may have at least two or more electrical inputs to receive electrical energy from the power source. The reinforcement structure may be defined as having a first electrical input and a second electrical input, where the first electrical input may be seen as a positive pole, while the second may be seen as a negative pole allowing the current to flow from the positive pole to the negative pole, or vice versa. Alternatively, each electrical input may be seen as both a positive and a negative pole, where the reinforcement network may be provided with a plurality of electrical inputs (i.e. two or more) where each electrical input may be configured to provide a part of the reinforcement network with a flow of current. This may be the case where the reinforcement network is of such a size, where one electrical input may not be enough to provide current to the entire reinforcement structure. Thus, in order to allow the reinforcement network to receive sufficient current to provide enough thermal energy, the reinforcement network may be provided with a number of electrical inputs, each having a connection to the power source and/or to a separate power source.

In one exemplary embodiment the distance between adjacent primary fibre structures and/or adjacent secondary fibre structures may be in the range between 5-40 mm, more preferably between 10-30 mm, more preferably between 12 and 20 mm, more preferably between 13 and 17 mm. The distance may e.g. be seen as the size of the mesh, where the distance may be used to define the peripheral distance of the mesh size of the reinforcement network. e.g. when the size is around 15 mm, the mesh may be defined as having a size that is about 15 mm×15 mm, as the distance defines the inner boundaries of the empty part of the grid. An empty part may mean that there are no fibre structures present in the empty part, while there may be other elements, such as plastic film, bitumen layers or other types of elements inside the empty space/area.

In one exemplary embodiment the bitumen layer may adhere the reinforcement network to the foundation layer. The bitumen layer may be a layer that is adapted to be applied, at least in part, to the first surface of the foundation layer, where the reinforcement layer may be positioned on top of the first surface of the foundation layer, and a bitumen layer is added to the top of the reinforcement layer. Subsequently, a top surface layer may be added on top of the reinforcement layer and/or the bitumen layer, where the bitumen layer bonds the second surface of the top layer to the first surface of the foundation layer. The reinforcement layer may be positioned between the top surface layer and/or the foundation layer.

In one exemplary embodiment the top surface layer may have a bitumen content of between 1-10% by weight. The top surface layer may have a bitumen that allows the bitumen of the top surface layer to bond with the bitumen of the bituminous layer which is positioned below the top surface layer. The top surface layer may be positioned close to the reinforcement layer, so that any heat energy that is created by the reinforcement layer may be absorbed by the top surface layer, to increase the temperature of the top surface layer.

In one exemplary embodiment the reinforcement network may be impregnated by about 150-300 g. pr. m² of bitumen, more specifically between 225-300 g. pr. m² of bitumen. The impregnation of the reinforcement network may be done prior to the application of the reinforcement network to the transport surface reinforcement system. The impregnation may be used to bond the strands of the primary and/or the secondary fibre structures together. Furthermore, or alternatively, the impregnation may be used to coat the fibre structures of the reinforcement network prior to installation, so that the reinforcement network may have a bituminous content prior to installation. The impregnation may assist the interaction between the reinforcement network and/or the bituminous layer and/or the top surface layer, so that the reinforcement network may increase the strain resistance of the top surface layer when the reinforcement network is present in the transport surface reinforcement system. Furthermore, the impregnation may assist the reinforcement layer in transmitting the thermal energy from the reinforcement network into the bituminous layer. The impregnation may ensure that there is a reduced risk that there is an area where air is trapped between the reinforcement layer and the bituminous layer, as an air pocket may function as a thermal insulator between two layers. Thus, the impregnation may improve the heat conductivity between the reinforcement layer and the bituminous layer and the top surface layer, in order to increase the temperature of the top surface layer when electricity is applied to the reinforcement layer.

In one exemplary embodiment the reinforcement network may be pre-encapsulated in a bituminous layer. This means that the reinforcement network may comprise a bituminous layer which may fully enclose the strands and/or the bundle of strands of the reinforcement network. This may mean that the strands or the bundle of strands of the reinforcement layer may abut each other, while the outer surface of the strands or the bundle of strands is covered in a bituminous layer, similar to a plastic coating of an electrical wire. The pre-encapsulation may extend around the entire outer surface of the strand or the bundle of strands, so that prior to the installation of the reinforcement network the fibres are not exposed to the exterior environment.

In one exemplary embodiment, the top surface layer may have a bitumen content of about 300-450 grams pr. m². The top surface layer may include a predetermined content of polymer, which may assist in keeping the top surface layer softer in the winter time, while being harder in the summertime, where the polymer may react to the temperature of the surroundings and/or the temperature in the top surface layer.

In one embodiment the bituminous layer may be applied to the reinforcement network and/or the foundation layer in the form of an emulsified mixture of water and bitumen.

In one embodiment, the height of the top surface layer may be around 30 mm, which may be suitable for a top surface layer for a motorway grade transport surface. The height of the top surface layer may be around 20 mm having a thin layer on top of the bituminous layer. In other embodiments the height of the top surface layer may be 50 mm or less.

A transport surface system may comprise from top to bottom, of an asphalt wearing surface, an asphalt intermediate layer, an asphalt base layer, an aggregate base, and subsoil. A person skilled in the art would understand based on the present disclosure, that the reinforcement system may be used in any of the layers of a transport surface system, and based on experiments would allow the thermal energy to reach the topmost layer of the system.

### BRIEF DESCRIPTION OF THE DRAWINGS

The subject matter will now be described in further detail in relation to exemplary embodiments, by way of example only, with reference to the drawings, in which:

FIG. 1 is an exploded view of a transport surface reinforcement system according to an embodiment of the described subject matter;

FIG. 2 is a sectional view of a transport surface reinforcement system according to an embodiment of the described subject matter;

FIG. 3a-3c are schematic illustrations of a primary fibre structure of the transport surface reinforcement system according to an of the described subject matter that may intersect with a secondary fibre structure;

FIG. 4a-4b are, respectively, schematic illustrations of a normal picture and an IR-picture superimposed with a visual light picture; and

FIG. 5a-5b are, respectively, schematic illustrations of a superimposed visual and IR picture for mesh with 2 threads cut near the bottom of the picture, and both an area with the center of the coil and another colder area is seen under the temperature numbers.

### DETAILED DESCRIPTION

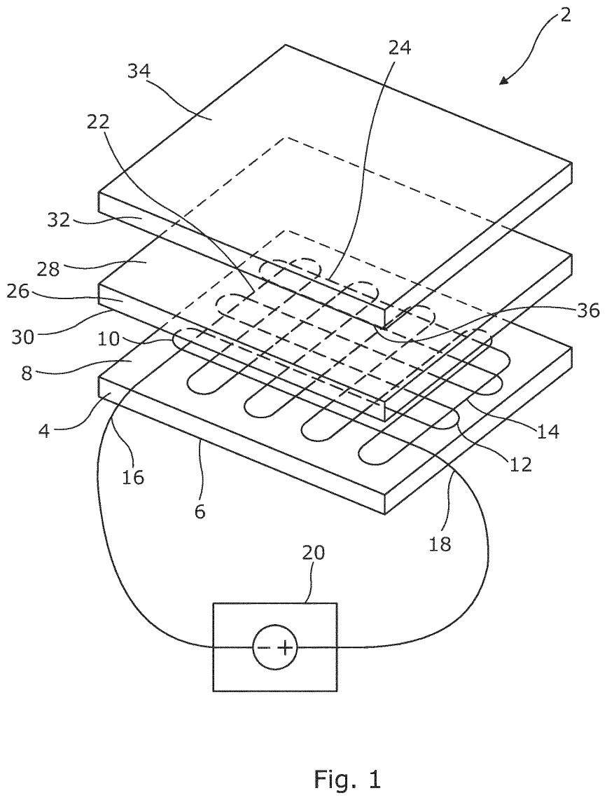

FIG. 1 shows a schematic exploded view of a transport surface reinforcement system 2 according to an embodiment of the described subject matter, comprising a foundation layer 4, where the foundation layer may be a layer of gravel or any kind of stabilizing gravel that may function as a solid foundation for laying a transport surface. The foundation layer 4 may be arranged on a ground surface, where the foundation layer provides the stable surface which distributes the pressure force applied from the transport surface system into the ground. The foundation layer may have a second surface 6 which faces the ground and a first surface 8 facing the opposite direction, e.g. facing the atmosphere.

The transport surface reinforcement system may further comprise a reinforcement network 10, where the reinforcement network 10 may be positioned on top of the first surface 8 of the foundation layer 4, and where the second surface 12 of the reinforcement network 10 may abut the foundation layer 4 when it is positioned on top of the foundation layer 4.

The reinforcement network may be in the form of S&P Carbophalt® G 200/200, which is a bitumen impregnated carbon fibre network, having mask sizes of 15×15 mm. The E-modulus of the carbon fibre may be between 240.000 N/mm² and 265.000 N/mm², having an extension at break of less than 1.9%, a tensile strength of 200 kN/m at <1.5% elongation, and having a fibre diameter of 46-47 mm²/m, or having around 50-52 fibres in a sectional diameter.

The primary fibre structure 22 may extend in one direction X, while the secondary fibre structure 24 may extend in a second direction Y, where the directions X and Y lie in the same plane, and where the direction X may be at an angle to the direction Y. The angle between X and Y may be at around 90 degrees, or between 85 and 95 degrees in the areas where the primary fibre structure intersects the secondary fibre structure.

The transport surface reinforcement system may further comprise a bituminous layer 26, where the bituminous layer 26 may have a first surface 28 and a second surface 30, where the second surface 30 faces the reinforcement network 10 and/or the foundation layer 4. The bituminous layer may be applied to the foundation layer 4 and/or the reinforcement network in the form of an emulsion where the bitumen may be mixed into a liquid substance, such as water. When the emulsion has been applied onto the foundation layer 4 and the reinforcement network, the liquid may evaporate leaving the bitumen as a separate layer in the transport surface system.

When the bituminous layer has been properly prepared for the transport surface system, the top surface layer 32 may be applied on top of the bituminous layer 26, where the top surface layer 32 has a first surface 34 and a second surface 36. The bituminous layer may be in contact with the first surface 8 of the foundation layer 4, as well as the second surface 36 of the top surface layer 32. Thus, the bituminous layer 26 may be used to bond the top surface layer 32 to the foundation layer. Furthermore, the presence of the reinforcement network 10 in the transport surface reinforcement system, allows the reinforcement network 10 as a tension device, to increase the tensile strength of the top surface layer and/or the bituminous layer, and thereby increase the top surface layer's resistance in the directions X and Y, and also thereby in the height direction.

During the installation of the layers, the layers may be compacted using heavy duty machinery, such as road rollers, which uses the force of gravity and/or vibration to compact the layers, and thereby reduce the risk that the layers will separate from each other after installation.

The reinforcement network 10 may have a first electrical connection 16 and a second electrical connection 18, where a power source 20 is attached to the first 16 and the second electrical connections 18 to allow an electrical current to run through the reinforcement network 10 via the primary fibre structure 22 and/or the secondary fibre structure 24. The fibre structure may be of the kind where the resistance and/or impedance of the fibre structure causes the electrical current to transform into thermal energy, i.e. heat, so that the heat may be transferred from the fibre structure to the top surface layer of the transport surface system.

The transport surface reinforcement system 2 may extend along a road, runway, and may have side peripheries, i.e. where the road, runway, taxiway stops, while the transport surface system may extend for short or long distances, where the transport surface system may have all the layers defined in the claims along the entire length and/or width.

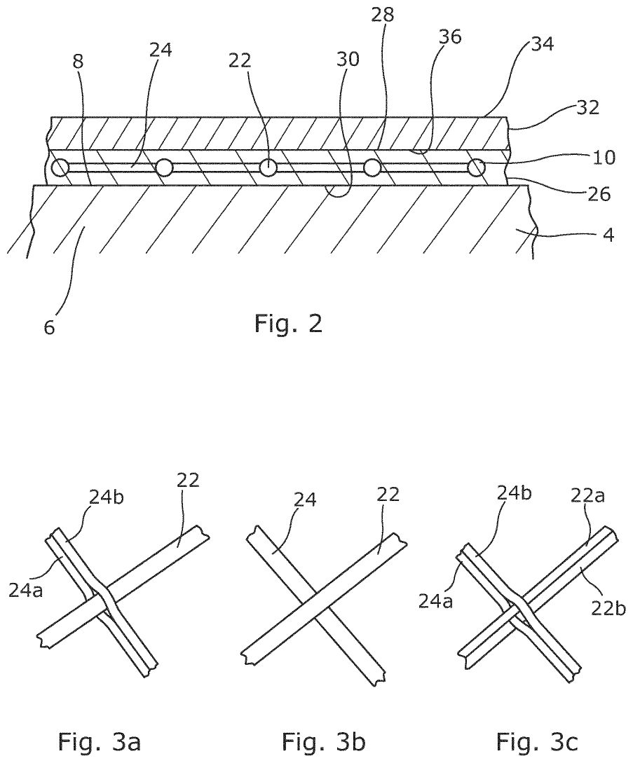

FIG. 2 shows a schematic sectional view of a transport surface reinforcement system 2 (shown in FIG. 1) in accordance with the present disclosure. The bottom layer of system 2, may be seen as the foundation layer 4, where the top surface 8 of the foundation layer 4 abuts the bottom surface 30 of the bituminous layer 26. In this example, the bituminous layer 26 may encase the reinforcement network 10 on all sides, so that the reinforcement network is only in contact with the bituminous substance. Furthermore, the reinforcement network 10 may be coated with a bituminous substance prior to installation into the transport surface reinforcement system, so that the application of the bituminous layer 26 binds and/or integrates with the bituminous coating of the reinforcement network.

FIG. 3a-3c show schematic embodiments according to an embodiment of the described subject matter where the primary fibre structure 22 may intersect with the secondary fibre structure 24. In FIG. 3a, the secondary fibre structure may be divided into a first bundle 24a and a second bundle 24b, where the second bundle may pass over the primary fibre structure 22 on the top surface 14 (shown in FIG. 1) of the structure, while the second bundle may pass below. These bundles may be interchangeable between the primary and/or the secondary fibre structure, so the primary fibre structure may be divided into two bundles. FIG. 3b shows a very simple embodiment, where the primary fibre structure 22 passes below the secondary fibre structure 24. This may also be done vice versa, where the primary fibre structure 22 passes above the secondary fibre structure 24. FIG. 3c shows another embodiment, where both the primary fibre structures 22 and the secondary fibre structures 24 are divided into two bundles 22a, 22b, and 24a and 24b, respectively, where the primary and secondary structures may alternate from the top to the bottom, or vice versa.

Various exemplary embodiments and details are described hereinafter, with reference to the figures when relevant. It should be noted that the figures may or may not be drawn to scale and that elements of similar structures or functions are represented by like reference numerals throughout the figures. It should also be noted that the figures are only intended to facilitate the description of the embodiments. The figures are not intended as an exhaustive description of the disclosure or as a limitation on the scope of the disclosure. In addition, an illustrated embodiment need not have all the aspects or advantages shown. An aspect or an advantage described in conjunction with a particular embodiment is not necessarily limited to that embodiment and can be practiced in any other embodiments even if not so illustrated, or if not so explicitly described. The scope of the described subject matter is that as set forth in the appended claims.

The use of the terms “first”, “second”, “third” and “fourth”, “primary”, “secondary”, “tertiary” etc. does not imply any particular order, but are included to identify individual elements. Moreover, the use of the terms “first”, “second”, “third” and “fourth”, “primary”, “secondary”, “tertiary” etc. does not denote any order or importance, but rather the terms “first”, “second”, “third” and “fourth”, “primary”, “secondary”, “tertiary” etc. are used to distinguish one element from another. Note that the words “first”, “second”, “third” and “fourth”, “primary”, “secondary”, “tertiary” etc. are used here and elsewhere for labelling purposes only and are not intended to denote any specific spatial or temporal ordering.

Furthermore, the labelling of a first element does not imply the presence of a second element and vice versa.

It is to be noted that the word “comprising” does not necessarily exclude the presence of other elements or steps than those listed.

It is to be noted that the words “a” or “an” preceding an element do not exclude the presence of a plurality of such elements.

It should further be noted that any reference signs do not limit the scope of the claims.

Although features have been shown and described, it will be understood that these are not intended to limit the claimed invention, and it will be made obvious to those skilled in the art that various changes and modifications may be made without departing from the scope of the described subject matter as set forth in the appended claims. The specification and drawings are, accordingly to be regarded in an illustrative rather than restrictive sense. The claimed subject matter is intended to cover all alternatives, modifications, and equivalents within the scope of the appended claims.

### EXPERIMENTAL DATA

### Experiment 1

Experiments were made of a Carbon-fibre mesh and carbon-fibre thread to measure conductivity with a four-point probe method and infrared images of heating. The Test Report was made by the Danish Technological Institute, and has a Test Report number 933984.

### Test

Measurement of conductivity of the carbon-fibre mesh with a four-point probe method expanded to measure area or surface resistivity on grid. Infrared, heat pictures are illustrating the heating of the mesh.

### Test Methods

Four-point probe method used on carbon fibre thread or rectangular piece of mesh. Current run via the outer electrodes and voltage is measured with the inner electrodes. The distance between the inner electrodes is measured. See pictures below (in the Figures). The same method is used for measurements on individual threads. On the larger rectangular pieces, a separate power supply was used, for the single threads a Sourcemeter was used, it is a combined voltage measurement and current source. The measurements were made fast to avoid the samples becoming warm.

### Samples

Carbon-fibre mesh with bitumen. The narrower threads are in the warp direction, the broader threads are in the weft direction. The weft threads are doubled in the weaving. The mesh has about 20 mm between each thread in both directions.

Measurements are done on single threads from both directions. Pieces with 10 threads 20 cm broad and about 100 cm long in both the weft and warp direction. Measurements of change in resistance with one and two of the threads cut is also measured. A measurement on a single thread from a spool was done as well. Finally, IR pictures are taken, of the piece with cut threads and of a larger section used for heating test.

### Equipment

Keithley 2400 Sourcemeter series number 945453 calibrated 20 Jun. 2017, Keithley 2260B-30-108.

Bench Power Supply received calibrated 11 Jan. 2019, Distance measuring device.

### Test Results

The measurement data can be found in the enclosure. A summary appears in Table 1 below.

TABLE 1

| | Resistance | Resistance | Surface |
|---|---|---|---|
| | per distance | per thread | resistivity |
| | [Ohm/m] | [Ohm/m] | σs [Ohm] |
| Warp direction resistance, | 1.73 | 17.3 | 0.35 |
| 10 threads in mesh | | | |
| Weft direction resistance, | 1.81 | 18.1 | 0.36 |
| 10 threads in mesh | | | |
| Warp direction resistance, | | 17.8 | |
| single thread | | | |
| Weft direction resistance, | | 20.4 | |
| single thread | | | |
| Single thread from spool | | 33.9 | |

The resistance per thread is very similar between the measurements on threads with bitumen and sand. The exception is the weft direction single thread where one of the threads measured pulled the average up.

Example of how to calculate resistance of a larger section

$$R = {σ}_{s} \times \frac{L}{W}$$

The resistance, R, of a large piece of carbon-fibre mesh is calculates as follows. If the width, W, is 1.2 meter, the length, L, is 26 meters. The resistance R=σs*L/W=0.35 Ohm*26 meter/1.2 meter=7.6 Ohm.

The Power, P, at 230 V will be P=U2/R=(230 V)2/7.6 Ohm=7.0 kW over 26 m*1.2 m=31.2 m2 it is 243 W/m2 and the Current is 30.3 A. How high a temperature this results in, will depend on the cooling of the surface.

### The Influence of Cutting One or Two Threads.

On a measurement in weft direction (sample F) measurements were made with 0, 1 and 2 threads cut. The result was a small increase in resistance. If only the longitudinal threads were conducting, the resistance should grow from R=R1/10 to R1/9 and R1/8 as one and two out of 10 threads were cut.

TABLE 2

| Threads | Distance | Current | Voltage | Resistance | Resistance/length |
|---|---|---|---|---|---|
| cut | [cm] | [A] | [V] | [Ohm] | [Ohm/m] |
| 0 | 97.5 | 10 | 18.9 | 1.89 | 1.94 |
| 1 | 97.5 | 10 | 19.2 | 1.92 | 1.97 |
| 2 | 97.5 | 10 | 19.7 | 1.97 | 2.02 |

### Heating of an Area

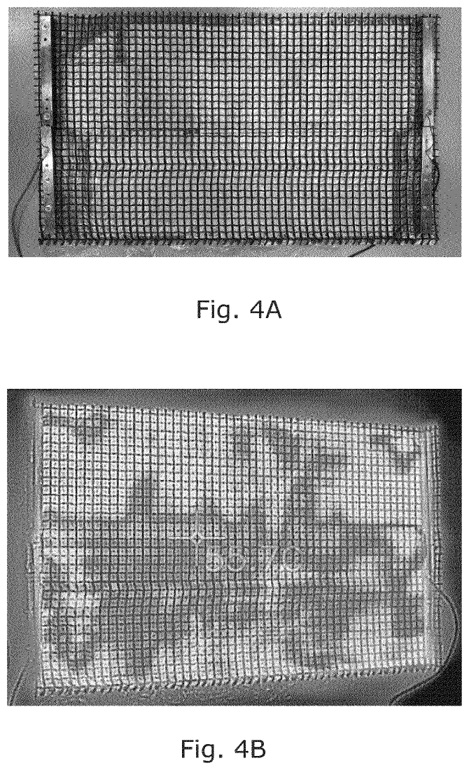

A larger section 66 cm by 101 cm with 34 threads in the warp direction were heated while monitoring with an IR camera. FIG. 4A shows a normal picture and FIG. 4B an IR-picture superimposed with a visual light picture. The temperature of the mesh is not uniform, but this seems more to be due to differences in contact with the floor below, than from differences in power transmitted in the different sections. There are no significant hotspots or cold spots.

Experiments were made of a Carbon-fibre mesh and carbon-fibre thread to measure induction heating of carbon fibre with mesh bitumen. The Test Report was made by the Danish Technological Institute, and has a Test Report number 942752.

Experiment 1 indicates that the current appears to flow in a transverse direction in the mesh, i.e. in the threads that are transverse, which means that if there are threads that are cut, there appears to be a thermal production on both sides of where the threads are cut.

### Experiment 2

Induction Heating of Carbon-Fibre Mesh with Bitumen.

### Test Methods

The mesh is placed on an insulating plate 14 mm thick over the coil producing the magnetic field. The insulating plate ensures the mesh can be heated with few limitations and that the water-cooled coil does not cool the mesh. The frequency is 66 k Hz, the current in the coil is 320 A, the coil is 40 mm in inner diameter and consists of 6 mm cobber tubing, there are 10 windings in the coil. The power is about 1.7 kW.

### Samples

Carbon-fibre mesh with bitumen. The narrower threads are in the warp direction, the broader threads are in the weft direction. The weft threads are doubled in the weaving. The mesh has about 20 mm between each thread in both directions.

### Equipment

Ultraflex Power induction system with coil. ID 40 mm.

### Test Results

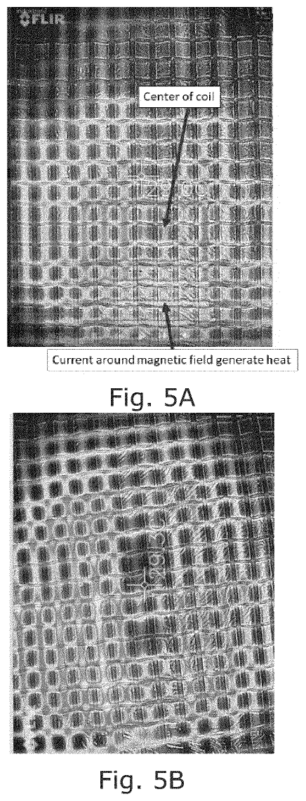

We can observe that the magnetic field produced by the induction coil gives rise to heating of the mesh. It is observed around the position where the coil is as illustrated in FIG. 5A. When the mesh is cut so the field is near the edge, the number of threads, for the current to use, is lower and there is more heating.

FIG. 5A shows a superimposed visual and IR picture for mesh with 2 threads cut near the bottom of the picture. FIG. 5B shows both an area with the center of the coil and another colder area is seen under the temperature numbers. This may indicate a missing connection between the vertical and horizontal threads.

Each feature disclosed in this specification (including the accompanying claims and drawings), may be replaced by an alternative feature(s) serving the same, equivalent or similar purpose, unless expressly stated otherwise. Thus, unless expressly stated otherwise, each feature disclosed is one example only of a generic series of equivalent or similar features. In addition, all of the features disclosed in this specification (including the accompanying claims and drawings), and/or all of the steps of any method or process so disclosed, may be combined in any combination, except combinations where at least some of such features and/or steps are mutually exclusive.

Accordingly, while many different embodiments of the present invention have been described above, with features, any one or more or all of the features described, illustrated and/or claimed in the appended claims may be used in isolation or in various combinations in any embodiment. As such, any one or more feature may be removed, substituted and/or added to any of the feature combinations described, illustrated and/or claimed. For the avoidance of doubt, any one or more of the features of any embodiment may be combined and/or used separately in a different embodiment with any other feature or features from any of the embodiments.

As such, the true scope of the invention is that set out in the appended claims.

1. A transport surface reinforcement system comprising:
a foundation layer having a first surface and a second surface,
a top surface layer having a first surface and a second surface,
a bituminous layer having a first surface and a second surface, where the second surface of the bituminous layer faces the first surface of the foundation layer,
a reinforcement network having a first surface and a second surface, where the reinforcement network is arranged on the first surface of the foundation layer, or between the foundation layer and the top surface layer, where the reinforcement network comprises
a plurality of primary fibre structures extending along a primary axis, where the plurality of primary fibre structures are arranged at a distance from each other in a direction of a secondary axis
a plurality of secondary fibre structures extending along the secondary axis, where the plurality of primary fibre structures are arranged at a distance from each other in a direction of the primary axis,
where at least one primary fibre structure intersects a secondary fibre structure,
at least one electrical input,
a power source having an electrical output which is electrically connected to the reinforcement network configured to transfer electrical energy into the electrical input of the reinforcement network.

2. A transport surface reinforcement system as set forth in claim 1, wherein each of the primary fibre structures and/or each of the secondary fibre structures comprises a bundle of fibre strands.

3. A transport surface reinforcement system as set forth in claim 1 wherein each of the primary fibre structures and/or each of the secondary fibre structures is made of at least 50% of carbon fibre strands.

4. A transport surface reinforcement system as set forth in claim 1, wherein the reinforcement network transforms the electrical energy into heat.

5. A transport surface reinforcement system as set forth in claim 1, wherein at least a first and/or a second surface of one of the primary fibre structures intersects at least a first and/or a second surface of one of the secondary fibre structures.

6. A transport surface reinforcement system as set forth in claim 1, wherein each of the primary fibre structures and/or the secondary fibre structures has a first fibre bundle and a second fibre bundle extending parallel to each other, where an intersecting secondary fibre structure and/or primary fibre structure passes between the first fibre bundle and the second fibre bundle.

7. A transport surface reinforcement system as set forth in claim 1, wherein the primary fibre structures are woven with the secondary fibre structures (the primary fibre structures may alter between being above and beyond the secondary fibre structures).

8. A transport surface reinforcement system as set forth in claim 1, wherein intersecting primary fibre structures and the secondary fibre structures are moveable along the primary axis and/or the secondary axis prior to application of a bituminous layer such that the fibre structures are not fixed relative to each other.

9. A transport surface reinforcement system as set forth in claim 1, wherein at least part of the reinforcement network penetrates a second surface of a bituminous layer.

10. A transport surface reinforcement system as set forth in claim 1, wherein the electrical energy is DC current.

11. A transport surface reinforcement system as set forth in claim 1, wherein the reinforcement network has at least two or more electrical inputs to receive electrical energy from the power source.

12. A transport surface reinforcement system as set forth in claim 1, wherein the distance between adjacent primary fibre structures and/or adjacent secondary fibre structures is in the range between 5-40 mm, more preferably between 10-30 mm, more preferably between 12 and 20 mm, more preferably between 13 and 17 mm.

13. A transport surface reinforcement system as set forth in claim 1, wherein a bitumen layer adheres the reinforcement network to the foundation layer.

14. A transport surface reinforcement system as set forth in claim 1, wherein the top surface layer has a bitumen content of between 1-10% by weight.

15. A transport surface reinforcement system as set forth in claim 1, wherein the reinforcement network is impregnated by about 150-300 g. pr. m² of bitumen, more specifically between 225-300 g. pr. m² of bitumen.

16. A transport surface reinforcement system as set forth in claim 1, wherein the reinforcement network is pre-encapsulated in a bituminous layer wherein the reinforcement network comprises a bituminous layer fully enclosing the network layer.

17. A method of forming a transport surface reinforcement system comprising the steps of:
providing a foundation layer having a first surface and a second surface,
providing a top surface layer having a first surface and a second surface,
providing a bituminous layer having a first surface and a second surface, where the second surface of the bituminous layer faces the first surface of the foundation layer,
providing a reinforcement network having a first surface and a second surface, where the reinforcement network is arranged on the first surface of the foundation layer, or between the foundation layer and the top surface layer, where the reinforcement network comprises
a plurality of primary fibre structures extending along a primary axis, where the plurality of primary fibre structures are arranged at a distance from each other in a direction of a secondary axis
a plurality of secondary fibre structures extending along the secondary axis, where the plurality of primary fibre structures are arranged at a distance from each other in a direction of the primary axis,
where at least one primary fibre structure intersects a secondary fibre structure,
at least one electrical input,
providing a power source having an electrical output which is electrically connected to the reinforcement network configured to transfer electrical energy into the electrical input of the reinforcement network.
